(19) United States
(12) Patent Application Publication
(10) Pub. No.: US 2018/0178603 A1
(43) Pub. Date: Jun. 28, 2018

(54) TRACTION AID

(71) Applicant: Daniel THEROUX, Sorel-Tracy (CA)

(72) Inventor: Daniel THEROUX, Sorel-Tracy (CA)

(21) Appl. No.: 15/611,698

(22) Filed: Jun. 1, 2017

Related U.S. Application Data
(63) Continuation-in-part of application No. 15/368,506, filed on Dec. 2, 2016.
(60) Provisional application No. 62/386,429, filed on Dec. 2, 2015.

(51) Int. Cl. B60C 27/02; B60B 15/18; B60C 27/04

(52) U.S. Cl. CPC B60C 27/0292; B60B 15/18; B60B 2900/551; B60C 27/04; B60B 2900/721; B60C 27/0276

(57) ABSTRACT

A traction aid apparatus for a motor vehicle wheel. The apparatus has an elongated main body; a first securing member located at the first end or near the first end of the elongated main body and projecting downwardly comprising a surface for engaging a first side wall of the motor vehicle tire; a second securing member projecting from the elongated main body comprising a surface for engaging a second side wall of the motor vehicle tire opposite the first side wall of the motor vehicle tire, a tension mechanism connected to the elongated main body or the second securing member; and a flexible wheel engaging member that is configured to pass through an aperture in the motor vehicle wheel to the tension mechanism to secure the traction aid apparatus to the motor vehicle wheel.

### CROSS-REFERENCE TO RELATED APPLICATIONS

This application is a continuation in part of the U.S. patent application Ser. No. 15/368,506 filed on Dec. 2, 2016, that claims priority of provisional patent application 62/386,429 filed on Dec. 2, 2015, which are herein incorporated by reference.

### TECHNICAL FIELD

The present disclosure relates to a traction aid apparatus for motor vehicles.

### BACKGROUND

Motor vehicles can be stuck on terrain that is unfit for vehicular travel, such as snow, ice, gravel or mud, and more particularly when on a slope such as a hill or ditch. Most trucks (and other vehicles) fail to provide a limited-slip differential in their drive train. This means that when one wheel of an axle slips in soft or slippery terrain, no drive power is provided to the other wheel of the axle. This means that even if the terrain under the other wheel were able to provide sufficient traction to move the vehicle, the vehicle remains stuck because of the unsuitable terrain under the one wheel that is slipping. In soft terrain conditions, the slipping of the one wheel can cause digging of a hole exacerbating the situation. In snow and ice conditions, snow covering ice can provide some degree of traction, however, the slipping tire can strip away the snow, leaving only ice below the slipping wheel.

Applying traction chains to a vehicle wheel is impractical when the vehicle is already stuck, since chains are applied typically be driving the tire onto the chains.

Traditional traction devices are limited in the aid they can provide. The user positions the traction device under the tire having traction difficulties, which is not always possible and practical. Furthermore, in use, the traditional traction device may turn into a projectile by the spinning wheel, which can be a hazard for anyone standing close by and may even damage the motor vehicle.

Accordingly, there is a need for traction aid that significantly overcomes these disadvantages.

### SUMMARY

Applicant has discovered that sufficient traction can be provided to a tire using a traction aid device that attaches to the wheel and is wider than the wheel for engaging a greater area of the soft or slippery terrain. Because of the constraints imposed by most vehicles that have suspension components preventing the traction aid device from extending towards the vehicle, the device is arranged to extend more outwardly from the tire. Applicant has found that this asymmetry or eccentricity causes a twisting action on the device held onto the tire, however, Applicant has found that securing members engaging the side walls of the tire can be used effectively to brace the device against twisting on the tire so that a wider traction device can be used.

A first broad aspect is a traction aid apparatus for a motor vehicle wheel having a motor vehicle tire having an elongated main body with a length that is greater than the width of the motor vehicle tire, with a top surface having a ground engaging surface, a bottom surface having a tire tread engaging surface, a first end, a second end opposite to the first end. The traction aid apparatus also has a first securing member located at the first end or near the first end of the elongated main body and projecting downwardly with a surface for engaging a first side wall of the motor vehicle tire. The traction aid apparatus also has a second securing member projecting from the elongated main body having a surface for engaging a second side wall of the motor vehicle tire opposite the first side wall of the motor vehicle tire, wherein the second securing member is attached or attachable to the main body while the main body has a portion extending outwardly beyond the side wall of the motor vehicle tire located on the outside of the motor vehicle tire. The traction aid apparatus includes a tension mechanism connected to the elongated main body or the second securing member. The traction aid apparatus also has a flexible wheel engaging member that is attached to the first securing member, the second securing member or the elongated member and configured to pass through an aperture in the motor vehicle wheel to the tension mechanism to secure the traction aid apparatus to the motor vehicle wheel with the first securing member and the second securing member engaging with pressure the side walls of the motor vehicle tire to brace the main body from twisting on the tire as the portion of the main body engages the ground.

In some embodiments, the second securing member may be attached or attachable to the main body at a variable position to fit against different widths of motor vehicle tires. The main body may be U-shaped.

In some embodiments, the outer ground engaging surface may have a series of protrusions to engage the ground as the motor vehicle tire rotates and the outer ground engaging surface engages the ground. The inner tire tread engaging surface may have one or more anti-skid members configured to engage treads of the motor vehicle tire. The tension mechanism may be a winch attached to the adjustable mechanism from the bottom surface of the main body and, wherein the flexible wheel engaging member may be a strap configured to be secured to a securing element of the tension mechanism from the top surface of the main body.

The tension mechanism may be a winch attached to the adjustable mechanism from the bottom surface of the main body and, wherein the flexible wheel engaging member may be a strap configured to be secured to the first securing member. The tension mechanism may be a winch attached to the adjustable mechanism from the bottom surface of the main body and, wherein the flexible wheel engaging member may be a strap configured to be secured to the end of main body provided with the first securing member. The first and second securing members may be plates. In some embodiments, the traction aid apparatus may also include a wrench.

In some embodiments, the winch may have a shaft for receiving the flexible wheel engaging member and a rotary fastener, wherein the rotary fastener may be connected to the shaft and causes the shaft to turn when the rotary fastener is turned, and wherein the jaws of the wrench may be adapted to the dimensions of the rotary fastener so that the wrench can apply a torque to the rotary fastener when a force is applied to the wrench.

In some embodiments, the flexible wheel engaging member may be a strap, the apparatus further comprising a sleeve for receiving a portion of the strap to protect the strap from damage. In some embodiments, edges of the first securing member and edges of the second securing member that come into contact with the strap when tension is applied between the first securing member and the second member may be rounded out.

In some embodiments, the traction aid apparatus may include a tire arch support that extends from the elongated main body and that is shaped to come into contact with and support a portion of the motor vehicle tire when pressure is applied by the ground onto the tire arch support. The tire arch support may also have a ground engagement mechanism located along at least one edge of the tire arch support.

A second broad aspect is a method of providing additional traction to a vehicle that is trapped in difficult terrain using a traction aid apparatus. The method involves placing the traction aid apparatus on a tire surface of a rear wheel of the vehicle. The method includes passing a flexible wheel engaging member of the traction aid apparatus through an aperture in the rear wheel, the rear wheel comprising a tire. The method also involves applying tension to the flexible wheel engaging member using a tension mechanism of the traction aid apparatus in order to secure the traction aid apparatus to the wheel. The method entails running the vehicle, wherein the running the vehicle causes the rear wheel on which the traction aid apparatus is secured to rotate, wherein, after the rear wheel begins to rotate, a ground engaging member of the traction aid apparatus engages with the ground and provides additional traction to the vehicle.

In some embodiments, the applying tension may cause a second securing member of the traction aid apparatus to move towards a first securing member of the traction aid apparatus, the first securing member applying pressure on a first side wall of the rear wheel, and the second securing member applying pressure to a second side wall of the rear wheel, the first side wall of the rear wheel opposite the second side wall of the rear wheel.

In some embodiments, the engaging by the ground engaging member may be with a greater length of ground than that of the tire.

In some embodiments, subsequent to the passing a flexible wheel engaging member of the traction aid apparatus through an aperture in the rear wheel, the method may also involve placing a protective sleeve over at least a portion of the flexible wheel engaging member.

In some embodiments, the passing of the flexible wheel engaging member through an aperture in the rear wheel may be performed with the assistance of an attachment tool that is used to attach to and pull the flexible wheel engaging member through an aperture in the rear wheel. In some embodiments, after the passing of the wheel engaging member through the wheel, the flexible wheel engaging member may be connected to the tension mechanism prior to the applying tension. In some embodiments, where the tension mechanism comprises a winch, the applying tension may be performed by using a wrench used to turn a rotary fastener of the winch connected to a shaft of the winch, the turning of the shaft applying tension to the flexible wheel engaging member. In some embodiments, where the vehicle has at one of its rear sides two adjacent tires, the placing the traction aid apparatus on a tire surface may involve placing an elongated main body of the traction aid apparatus over an entire width of a first outer wheel of the adjacent wheels and at least a portion of a width of a second inner wheel of the adjacent wheels. The applying tension may cause a second securing member of the traction aid apparatus to move towards a first securing member of the traction aid apparatus, the first securing member applying pressure on a first side wall of the first outer wheel, and the second securing member applying pressure to a second side wall of the first outer wheel, the first side wall of the first outer wheel opposite the second side wall of the first outer wheel.

Applicant has also found that a traction aid device that attaches to a tire at one location (or at specific locations) poses a risk of causing a mechanical shock to the drive train when the tire is freely spinning until the traction aid engages and suddenly prevents such free spinning. This is the case for example when a tire is slipping on ice or snow. In particular, the differential of the drive train is at risk of damage when the traction aid on a spinning wheel strikes the ice or snow. Applicant has found that this risk of damage is mitigated by providing a progressively protruding traction aid attached to the tire. In this way, the initial engagement of the traction aid is not sufficient to suddenly stop the spinning wheel, but begins to create a frictional engagement with the ground to slow the spinning wheel and to provide some thrust to the vehicle. The final engagement of the traction aid is designed to ensure that the wheel essentially does not slip at all with respect to the terrain.

### BRIEF DESCRIPTION OF THE FIGURES

The invention will be better understood by way of the following detailed description of embodiments of the invention with reference to the appended drawings, in which:

FIG. 1 is a perspective view of an exemplary traction aid apparatus;

FIG. 2 is a bottom view of an exemplary traction aid apparatus;

FIG. 3 is a side view of an exemplary traction aid apparatus;

FIG. 4 is a perspective view of an exemplary traction aid apparatus positioned on a wheel of a vehicle;

FIG. 5A is a perspective view of an exemplary traction aid apparatus with a tire arch support configured to cover at least a portion of circumference of the tire;

FIG. 5B is a front view of an exemplary traction aid apparatus with a tire arch support configured to cover at least a portion of circumference of the tire;

FIG. 5C is a top view of an exemplary traction aid apparatus with a tire arch support configured to cover at least a portion of circumference of the tire;

FIG. 6 is a flowchart diagram of an exemplary method of freeing a vehicle that is trapped in difficult terrain by using at least one exemplary traction aid apparatus.

### DETAILED DESCRIPTION

Generally stated, the non-limitative illustrative embodiments of the present disclosure provide a traction aid (herein also referred as a traction aid apparatus) enabling a motor vehicle to move over a terrain that is unfit for vehicular travel, such as a terrain covered in snow, ice or mud, or any other such difficult terrain. The traction aid is composed of an elongated body configured to be secured to the wheel of a motor vehicle, the elongated body having a ground engaging surface on its top surface that comes into contact and engages the ground when the traction aid, attached to the wheel, turns with the wheel, where the ground engaging surface makes contact with the ground. Optionally, the traction aid may have on the ground engaging surface one or more series of protuberances or teeth allowing the motor vehicle to grip the ground of terrain and free itself from any stalling. The length of the elongated body may be such as to allow the traction aid to be fitted to the wheel of a motor vehicle and to engage more ground then the width of the wheel, thus improving its grip. In some examples, such as when the traction aid apparatus is tailored to assist larger and heavier vehicles where two wheels may be adjacent to one another on one side, the elongated body may be of a sufficient length to span at least one and half times the width of the tire, where the tire elongated body is of a length where it also extends beyond that of the tire. For instance, the elongated body may have a length greater than three halves the length of the tire, so that one extremity of the elongated body extends beyond the outer tire by a few inches, and the other extremity of the elongated tire may sit on the tire adjacent to the outer tire of the two wheels, placed side by side on one side of the vehicle. This allows the ground engaging member to engage with a greater length of ground than the length of ground engaged by the tire.

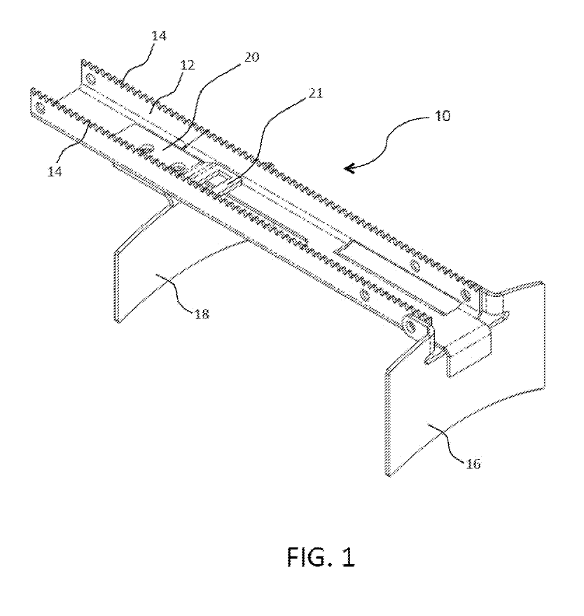

Referring to FIGS. 1 to 3, the traction aid 10 in accordance with an exemplary embodiment of the present disclosure is composed of an elongated, generally U-shaped, main body 12 that may have a ground engaging surface 33. It will be understood that the shape of the main body 12 may vary without departing from the present teachings (e.g. open-rectangular shape; open-square shape; open trapezoidal shape). Optionally, the ground engaging surface 33 may have a series of protuberances or teeth 14 along its upper extremities. The ground engaging surface 33 comes into contact with the ground, where, for instance, the series of protuberances 14 may dig into the ground as the wheel to which the traction aid 10 is attached turns and the traction aid 10 approaches the ground. At an end (this including, in some embodiments, near the end), the main body 12 is provided with a first securing member 16, for example a plate, projecting downwardly. The first securing member 16 may have a flexible mechanism (e.g. a hinge attached to the main body 12), where it may fold and/or flex towards and away from the main body 12. In some embodiments, the second securing member 18 may have a flexible mechanism where it may fold and/or flex towards and away from the main body 12. The second securing member 18, for example another plate, is movably attached or attachable to a bottom surface of the main body 12 via an adjustable mechanism 20. The adjustable mechanism 20 allows movement of the second securing member 18 towards or away from the first securing member 16. In some examples, the adjustable mechanism 20 may be a rail (where the second securing member 18, attached thereto, may move along the rail), a slide rail, where in other examples, it may have a telescopic arrangement (e.g. the adjustable mechanism may allow the second securing member 18 to lock into place at different positions). In other examples, the adjustable mechanism 20 may have openings along the main body 12, the openings configured to receive a complementary portion of the second securing member 18 and fixing the second securing member 18 into a desirable position in proximity of (and/or touching) the tire. In some examples, the adjustable mechanism 20 may be connected to the securing member 18 that is to be positioned on the inside wall of the wheel. In some embodiments, the adjustable mechanism 20 may be connected to the securing member 18 that is to be positioned on the outside wall of the wheel.

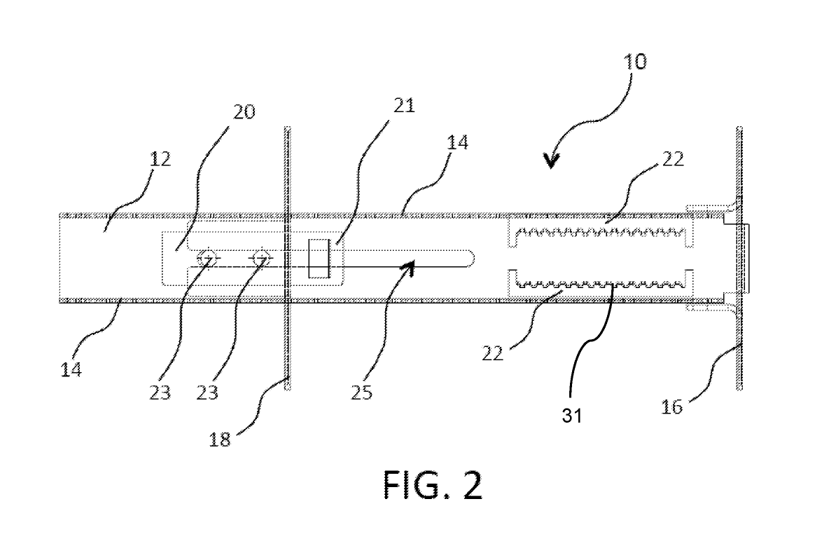

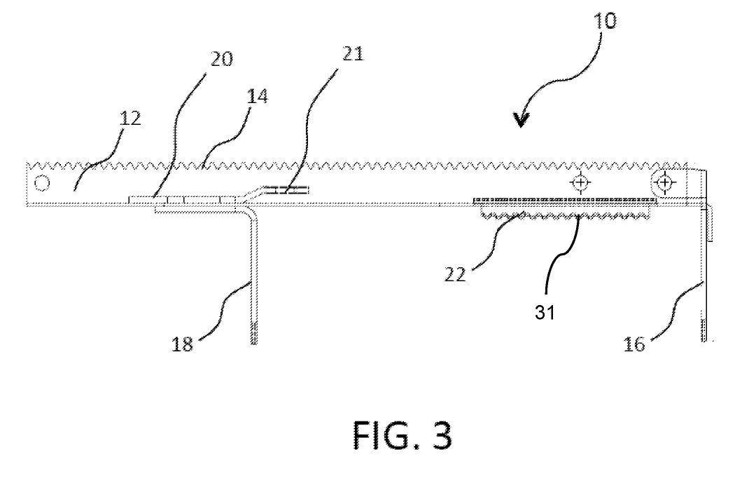

With reference to FIGS. 2 and 3, a bottom surface portion of the main body 12 located between the first 16 and second 18 securing members, the inner tire tread engaging surface 31, may be provided with one or more anti-skid members 22 (protuberances, teeth, corrugations, etc.).

The various parts of the traction aid 10 may be made, for example, of metal, stainless steel, aluminum, plastic, etc.

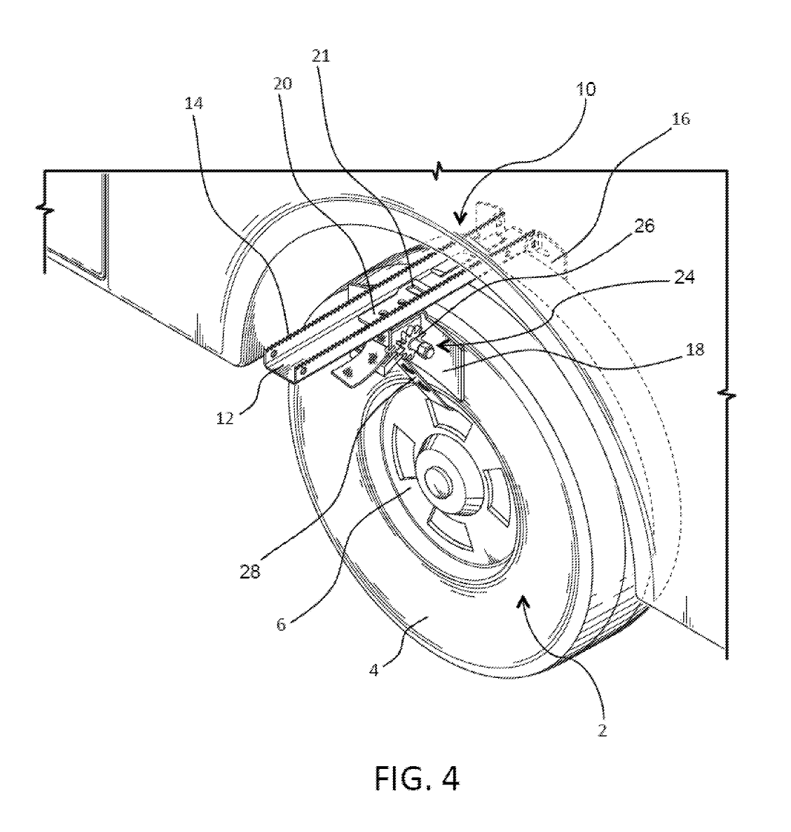

Referring now to FIG. 4, the traction aid 10 is further composed of a flexible wheel engaging member 24 connected to a tension mechanism 26, such as a winch, attached to the adjustable mechanism 20 from the bottom surface of the main body 12. The tension mechanism 20 may be connected to the main body 12. In some embodiments, the tension mechanism 20 may be connected to the first securing member 16 and/or the second securing member 18. The adjustable mechanism 20 may have a security element 21 to which the flexible wheel engaging member 24 may be secured from, for instance, a top surface of the main body 12. The flexible wheel engaging member 24 is configured to be inserted through an aperture in the vehicle wheel, such as between its frame and the spokes, and the tension mechanism 26 is configured to apply tension between the first securing member 16 and the second securing member 18. The flexible wheel engaging member 24 and tension mechanism 26 secure the traction aid 10 on the vehicle tire and limit movement of the main body 12 on the tread of the tire as the vehicle tire rotates and the outer ground engaging surface 33 engages the ground. The inner tire tread engaging surface 34 may further engage the tire as the tightening of the flexible wheel engaging member 24 brings the inner tire tread engaging surface 34 closer to the tire, pressing onto the tire.

In some embodiments, the tension mechanism is not connected to the second securing member 18, where the second securing member 18 may be moved to the first securing member 16 independently from the tension applied by the tension mechanism and the flexible wheel engaging member 24. For instance, the first securing member 16 and the second securing member 18 may be connected via a vice mechanism (not shown), where a user may use the vice mechanism to bring the second securing member 18 closer to the first securing member 16 and apply pressure to both the first and second securing members 16 and 18 so as to squeeze the wheel. In these embodiments, the flexible wheel engaging member 24 may still be present to loop around the tire and, using the tension mechanism 20, and may allow the further tightening of the traction aid apparatus 10 to the wheel as the flexible wheel engaging member 24 is tightened using the tension mechanism 20.

In some embodiments, the flexible wheel engaging member 24 may be a strap as shown in FIGS. 1 through 4. In other examples, the flexible when engaging member 24 may be an elastic with a high resistance that can be tightened using the tension mechanism 26. In other embodiments, the flexible wheel engaging member 24 may be at least one steel cable, and the tension mechanism 26 may be a winch. In other embodiments, the flexible wheel engaging member 24 may be a chain, such as a bicycle chain or motorcycle chain inserted through the holes of the wheel and wrapped around the wheel. The chain may then pass over a sprocket with a worm gear drive acting as the tension mechanism 26, the chain fitted to the sprocket, where the sprocket with the worm gear drive may apply additional tension on the wheel as the sprocket turns and the chain loses slackness. The tension mechanism 26 may have a threaded shaft, a ratchet or cam for providing the user with a mechanism to tighten the flexible wheel engaging member 24 using the tension mechanism 26. In some examples, the traction aid apparatus 10 may have a replacement mechanism for the flexible wheel engaging member 24, where the flexible wheel engaging member 24 may be removed and replaced by a new flexible wheel engaging member 24, in the case, for instance, of wear and tear, or if a flexible wheel engaging member with different properties is required (e.g. more narrow for passing through a specific tire type, more resistant, etc.)

In some examples, the strap may be protected by a sheath or protective sleeve to reduce, for instance, abrasion caused by the wheel on the strap. When the flexible wheel engaging member 24 is a cable or chain, the flexible wheel engaging member 24 may be used with a vehicle wheel having smaller openings in which may pass the flexible wheel engaging member 24.

In the examples where the flexible wheel engaging member 24 is a strap, the edges of the first securing member 16, the second securing member 18, and any other edge of the traction aid 10 that comes into contact with the strap, may be rounded out in order to reduce wear and tear of the strap as it rubs across the different edges of the traction aid 10 as the strap is being adjusted and/or tightened.

In the examples where the tension mechanism 26 has a rotary fastener 31, such as an ending shaped or consisting of a bolt or nut, the traction aid 10 may also include a wrench. The wrench may be used by the user to turn the rotary fastener 31 of the winch of the tension mechanism 26. The rotary fastener 31 may be connected directly or indirectly to the shaft of the winch. As a torque is applied by the wrench to the rotary fastener 31, the shaft turning with the rotary fastener 31 subjected to the torque, the flexible wheel engaging member 24 wraps around the shaft or the bar of the winch, causing the flexible wheel engaging member 24 to tighten around the wheel of the vehicle. The shaft of the winch may also have a slit through its center with a width sufficient to receive the strap. The passing of the strap through the slit of the winch may assist in the wrapping of the strap around the shaft as the shaft turns.

In use, the main body 12 of the traction aid 10 is positioned on top of the tire 4 of the motor vehicle wheel 2, parallel to its rotation axis, such that the first securing member 16 may be positioned on the side of the wheel 2 inside the wheel well and the second securing member 18 may be positioned on the opposite side of the wheel 2. Thus positioned, in some examples, the one or more anti-skid members 22 at the inner tire tread engaging surface 31 of the main body 12 between the first 16 and second 18 securing members may be put in contact with the treads of the tire 4 of the wheel 2, providing a gripping effect between the wheel 2 and the traction aid 10. The traction aid 10 is then secured to the wheel 2 by passing the flexible wheel engaging member 24 through, for instance, the rim 6 of the wheel 2. In an alternative embodiment the strap 24 may be secured to the first securing member 16 or the end of main body 12 provided with the first securing member 16. The winch 26 is then activated so as to tighten the strap 24, which moves the adjustable mechanism 20, and thus the second securing member 18, towards the first securing member 16, resulting in a vice effect effectively squeezing the tire 4 between the first 16 and second 18 securing members and thereby tightly securing the traction aid 10 to the wheel 2.

Referring back to FIG. 2, the second securing member 18 and the tension mechanism 26, both located on the bottom surface of the main body 12, may be attached to the adjustable mechanism 20 using, for instance, screws or bolts 23 passing through a slit 25 within the main body 12.

The length of the main body 12 combined with the adjustable mechanism 20 allows the traction aid 10 to accommodate various tire 4 widths. Advantageously, the length of the main body 12 is substantially longer than the width of the tire 4 in order to provide an improved ground gripping capability. In some embodiments, the main body 12 may extend beyond the outer side wall of the wheel when the traction aid apparatus 10 is placed on the wheel. It is to be understood, however, that in an alternative embodiment the length of the main body 12 may be closer to the width of the tire 4 in order to be more portable. In some embodiments, the length of the main body 12 may be sufficient to accommodate a vehicle (e.g. a large truck) having two tires placed adjacent to one another on one side of the vehicle. The main body 12 may span a sufficient length to cover at least three halves of the width of a large vehicle's tire. One end of the long body 12 may rest somewhere near the middle of the inner adjacent tire, where the other end of the long body 12 may extend (e.g. a few inches) beyond the outer face of the outer adjacent tire.

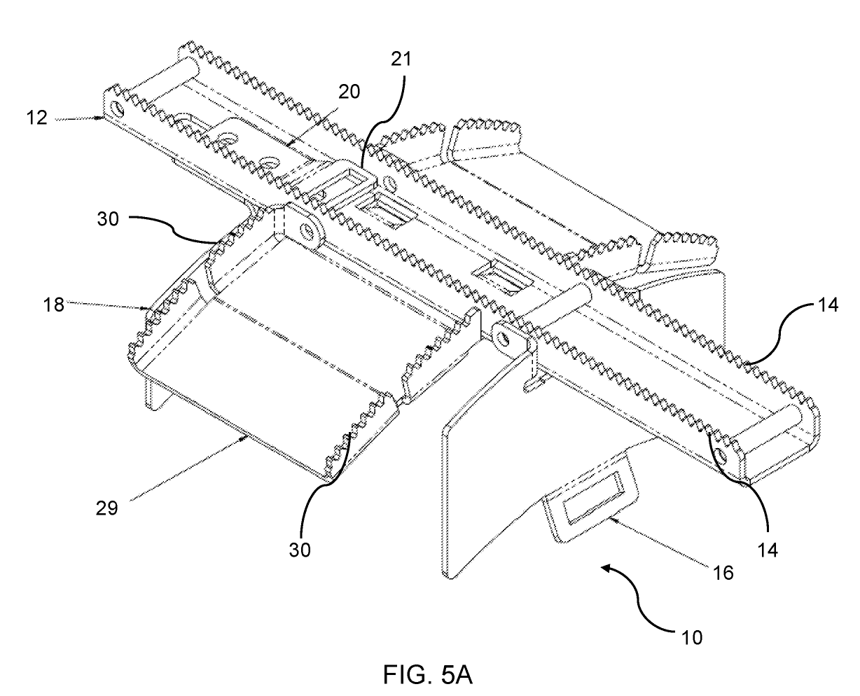

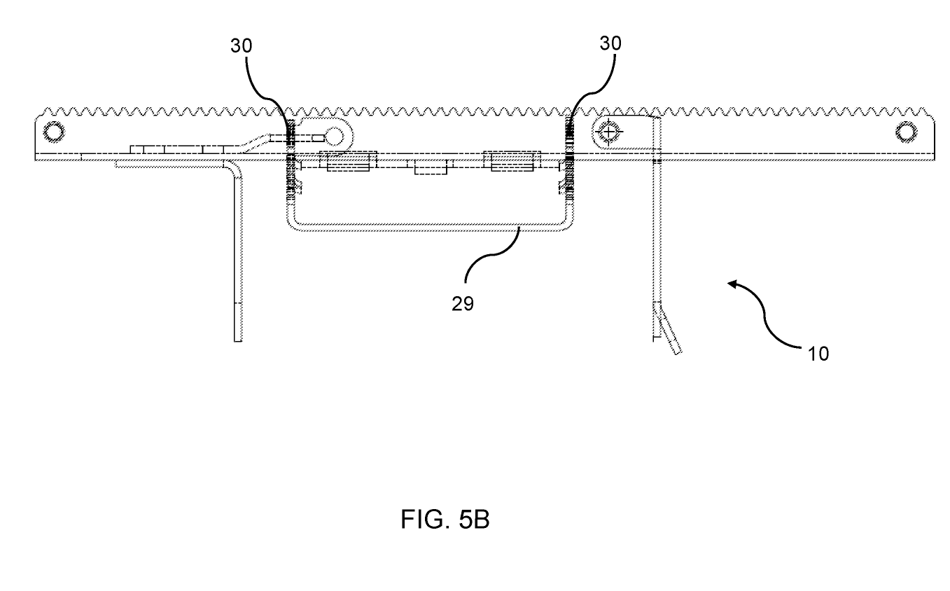

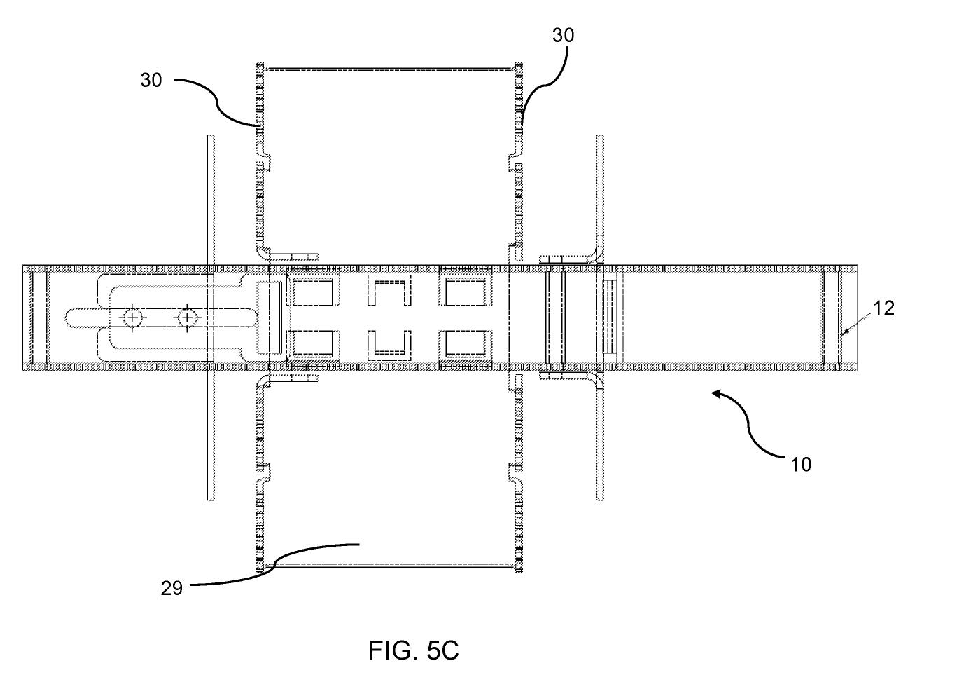

Reference is now made to FIGS. 5A to 5C, illustrating an exemplary traction aid apparatus 10 having a tire arch support 29 configured to span at least a portion of the circumference of the tire. The tire arch support 29 may span the whole width of the tire, or a portion of the width of the tire. The tire arch support 29 provides additional support to the wheel once the traction aid apparatus 10 is installed, and when the vehicle is running in order to free the vehicle from the vehicle terrain. When the traction aid apparatus 10, installed to the rear wheel of the vehicle, makes contact with the ground, the impact may risk damaging the differential of the vehicle. The tire arch support 29, with an arch shaped following at least a portion of the tire near the main body 12 of the traction aid apparatus 10, reduces the impact (e.g. initial impact) resulting from when the traction aid apparatus 10 meets the ground, which may alleviate the load and damage that can be caused to the differential of the vehicle. In some embodiments, the outer edges of the tire arch support 29 may be corrugated, having a series of protrusions 30, teeth, or any other ground engagement edge (such as a sharp edge) that can make contact with the ground. In some embodiments, the tire arch support 29 is a removable piece that can be locked onto the main body 12 of the traction aid apparatus 10 using a fastening mechanism (e.g. protrusions for placing within complementary openings on the tire arch support 29; screws; bolts; etc.). In some embodiments, the tire arch support 29 is composed of one continuous arch with optionally a flat surface where the tire arch support 29 is to meet the long body 12. In other embodiments, the tire arch support may be composed of several (at least one on either side of the long body 12) flat plates. The flat plates may be adjustable to shape to the arch of the tire of the vehicle. In some embodiments, the tire arch support 29 may be found on only one side of the main body 12 of the traction aid apparatus 10, such as the side of the traction aid apparatus 10 that will first come into contact with the ground as the wheel turns (e.g. the vehicle moves forward).

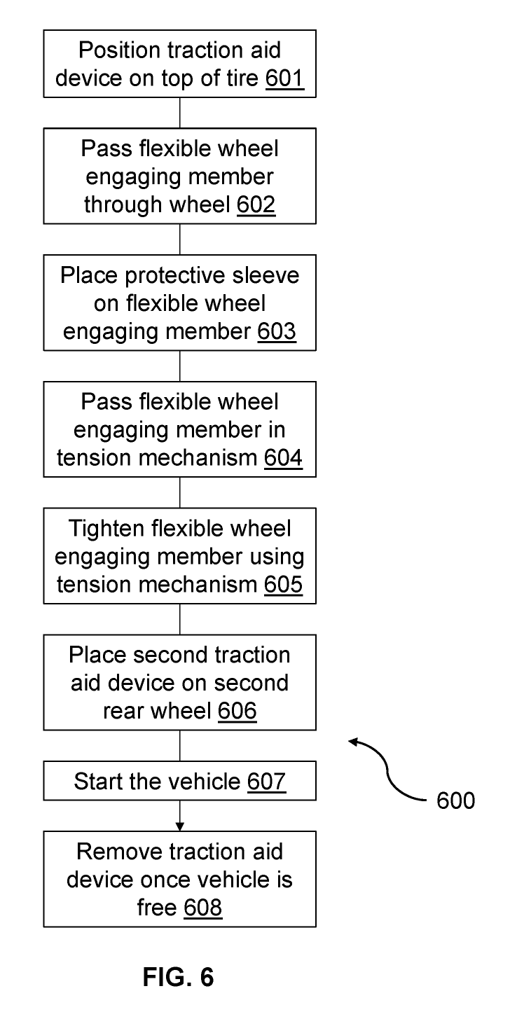

Reference is now made to FIG. 6, illustrating an exemplary method 600 for freeing a vehicle from difficult terrain (e.g. a vehicle is stuck in a rut, a ditch, on ice, in mud or in snow) using at least one exemplary traction aid apparatus 10.

The traction aid apparatus 10 may be first positioned on a rear wheel of the vehicle at step 601. In some examples, the traction aid apparatus 10 is preferably positioned on the top of the tire. In other examples, the traction aid apparatus 10 may cover the width of the tire while being placed on the side of the tire. When positioned, where the first securing member 16 may have a foldable and/or hinge mechanism, the first securing member 16 may fold towards the main body 12. This folding mechanism may facilitate the positioning of the traction aid apparatus 10 on the wheel. As the main body 12 slides over the tire, the tire pushes on the first securing member 16 that folds towards the main body 12, allowing for the traction aid apparatus 10 to slide over the tire. As the main body 12 moves over the tire towards the inner side of the tire, the first securing member 16 may then flip back out towards the tire, and fall outward (e.g. being roughly perpendicular with the length of the main body 12), dropping over the inner side of the wheel, positioned at or near the inside of the wheel. The position of the traction aid apparatus 10 over the wheel may result in the second securing member 18 being positioned on or close to the outside of the wheel. When the traction aid apparatus 10 is positioned over the wheel, the length of the main body 12 may be such that the main body 12 extends and protrudes beyond the outer side wall of the tire. In the examples where the vehicle has on one side two adjacent wheels (e.g. in the example of the large truck), where the traction aid apparatus 10 is positioned over the outer wheel, one of the extremities of the main body 12 may extend onto the inner tire, spanning at least a portion (e.g. half) of the width of the inner tire.

In some examples, the flexible wheel engaging member 24 is now located near the inside wall of the wheel. The flexible wheel engaging member 24 may be then passed through an aperture (e.g. the rim and/or spokes of the tire), pulled towards the outer surface of the wheel, towards the user at step 602. In some examples, the user may use an elongated tool with an attachment mechanism, such as a long thin appliance ending with a hook or a clip or some adhesive, to latch onto (or attach onto), and pull or feed the flexible wheel engaging member 24 through the rim and/or spokes.

In some embodiments, a protective sleeve may be placed on the flexible wheel engaging member 24 at step 603. The protective sleeve protects the flexible wheel engaging member 24 from wear and tear and damage, such as, for instance, abrasion from the tire and other components of the traction aid apparatus 10 rubbing against the flexible wheel engaging member 24, dirt, grime, and/or sharp edges that can damage and/or reduce the life span of flexible wheel engaging member 24. The protective sleeve may be, for example, a plastic casing or sock, a felt or textile sleeve, a thick protective film molded to the flexible wheel engaging member 24. The protective sleeve may cover at least a portion of the flexible wheel engaging member 24 (e.g. such as a portion of the flexible wheel engaging member 24 that comes into contact with a portion of the tire).

The flexible wheel engaging member 24 may then be connected to the tension mechanism 26 at step 604. In some examples, where the flexible wheel engaging member 24 is a strap, and the tension mechanism 26 is a winch with a shaft, where the shaft of the winch has a slit through its center with a width sufficient to receive the strap, the strap may be placed in the slit of the shaft.

The flexible wheel engaging member 24 is then tightened using the tension mechanism at step 605. In the examples where the flexible wheel engaging member 24 is a strap and the tension mechanism 26 is a winch, the passing of the strap through the slit of the winch assists with the wrapping of the strap around the shaft as the shaft turns, resulting in the strap tightening. As tension is applied to the flexible wheel engaging member 24, the second securing member 18 may be adjusted (e.g. slide) towards the tire (e.g. as tension is applied to the flexible wheel engaging member 24), the first and second securing members 16 and 18 squeezing the tire as the space between the first securing member 16 and the second securing member 18 is reduced. The traction aid apparatus 10 is then secured to the rear wheel of the vehicle.

In some examples, a second traction aid apparatus 10 may be placed on the second rear wheel of the vehicle at step 606, following the steps 601 to 605 for placing the second traction aid apparatus 10 on the tire.

The vehicle is then started at step 607 (e.g. the engine of the vehicle is turned on, and the vehicle is put into drive). The wheel of the vehicle turns and the traction aid apparatus 10, fastened to the wheel, may turn with the wheel, come into contact and engage with the ground (e.g. through the ground engaging surface 33, or the ground engaging edge 30), providing additional traction for the vehicle. This additional traction assists the vehicle in freeing itself from the difficult terrain.

Once the vehicle is freed from the difficult terrain, the traction aid apparatus 10, or traction aid apparatus 10, is removed from the wheel of the vehicle at step 608.

Although the present disclosure has been described with a certain degree of particularity and by way of illustrative embodiments and examples thereof, it is to be understood that the present disclosure is not limited to the features of the embodiments described and illustrated herein, but includes all variations and modifications within the scope of the disclosure as hereinafter claimed.

What is claimed is:

1. A traction aid apparatus for a motor vehicle wheel having a motor vehicle tire, comprising:
an elongated main body comprising a top surface having a ground engaging surface, a bottom surface having a tire tread engaging surface, a first end, a second end opposite to the first end;
a first securing member located at the first end or near the first end of the elongated main body and projecting downwardly comprising a surface for engaging a first side wall of the motor vehicle tire;
a second securing member projecting from the elongated main body comprising a surface for engaging a second side wall of the motor vehicle tire opposite the first side wall of the motor vehicle tire, wherein the second securing member is attached or attachable to the main body while the main body has a portion extending outwardly beyond the side wall of the motor vehicle tire located on the outside of the motor vehicle tire;
a tension mechanism connected to
the elongated main body or
the second securing member; and
a flexible wheel engaging member that is attached to the first securing member, the second securing member or the elongated member, and configured to pass through an aperture in the motor vehicle wheel to the tension mechanism to secure the traction aid apparatus to the motor vehicle wheel with the first securing member and the second securing member engaging with pressure the side walls of the motor vehicle tire to brace the main body from twisting on the tire as the ground engaging surface of the main body engages the ground.

2. The traction aid apparatus in accordance with claim 1, wherein the second securing member is attached or attachable to the main body at a variable position to fit against different widths of motor vehicle tires.

3. A traction aid apparatus in accordance with claim 1, wherein the outer ground engaging surface comprises a series of protrusions to engage the ground as the motor vehicle tire rotates and the outer ground engaging surface engages the ground.

4. A traction aid apparatus in accordance with claim 1, wherein the inner tire tread engaging surface comprises one or more anti-skid members configured to engage treads of the motor vehicle tire.

5. A traction aid apparatus in accordance with claim 1, wherein the tension mechanism is a winch attached to the adjustable mechanism from the bottom surface of the main body and, wherein the flexible wheel engaging member is a strap configured to be secured to a securing element of the tension mechanism from the top surface of the main body.

6. A traction aid apparatus in accordance with claim 1, wherein the tension mechanism is a winch attached to the adjustable mechanism from the bottom surface of the main body and, wherein the flexible wheel engaging member is a strap configured to be secured to the first securing member.

7. A traction aid apparatus in accordance with claim 1, wherein the tension mechanism is a winch attached to the adjustable mechanism from the bottom surface of the main body and, wherein the flexible wheel engaging member is a strap configured to be secured to the end of main body provided with the first securing member.

8. A traction aid apparatus in accordance with claim 1, wherein the first and second securing members are plates.

9. A traction aid apparatus in accordance with claim 6, wherein the winch comprises:
a shaft for receiving the flexible wheel engaging member; and
a rotary fastener,
wherein the rotary fastener is connected to the shaft and causes the shaft to turn when the rotary fastener is turned, and wherein the jaws of the wrench are adapted to the dimensions of the rotary fastener so that the wrench can apply a torque to the rotary fastener when a force is applied to the wrench.

10. A traction aid apparatus in accordance with claim 1, further comprising a tire arch support attached or attachable to the elongated main body and that is shaped to substantially follow the shape of a portion of the tire and is configured to come into contact with a portion of the motor vehicle tire at least when pressure is applied by the ground to the tire arch support.

11. The traction aid apparatus in accordance with claim 10, wherein said tire arch support further comprises a ground engagement edge located along at least one edge of the tire arch support.

12. A method of providing additional traction to a vehicle that is trapped in difficult terrain using a traction aid apparatus comprising:
placing the traction aid apparatus on a tire surface of a rear wheel of the vehicle, the rear wheel comprising a tire;
passing a flexible wheel engaging member of the traction aid apparatus through an aperture in the rear wheel;
applying tension to the flexible wheel engaging member using a tension mechanism of the traction aid apparatus in order to secure the traction aid apparatus to the wheel; and
running the vehicle, wherein the running the vehicle causes the rear wheel on which the traction aid apparatus is secured to rotate, wherein, after the rear wheel begins to rotate, a ground engaging member of the traction aid apparatus engages with the ground and provides additional traction to the vehicle.

13. The method in accordance with claim 12, wherein the applying tension causes a second securing member of the traction aid apparatus to move towards a first securing member of the traction aid apparatus, the first securing member applying pressure on a first side wall of the rear wheel, and the second securing member applying pressure to a second side wall of the rear wheel, the first side wall of the rear wheel opposite to the second side wall of the rear wheel.

14. The method in accordance with claim 12, wherein the engaging by the ground engaging member is with a greater length of ground than that of the tire.

15. The method in accordance with claim 12, further comprising, subsequent to the passing a flexible wheel engaging member of the traction aid apparatus through an aperture in the rear wheel, placing a protective sleeve over at least a portion of the flexible wheel engaging member.

16. The method in accordance with claim 12, wherein the passing of the flexible wheel engaging member through an aperture in the rear wheel is performed with the assistance of an attachment tool that is used to attach to and pull the flexible wheel engaging member through the wheel.

17. The method in accordance with claim 12, wherein, after the passing of the wheel engaging member through an aperture in the rear wheel, the flexible wheel engaging member is connected to the tension mechanism prior to the applying tension.

18. The method in accordance with claim 12, wherein the tension mechanism comprises a winch, wherein the applying tension is performed by using a wrench used to turn a rotary fastener of the winch connected to a shaft of the winch, the turning of the shaft applying tension to the flexible wheel engaging member.

19. The method in accordance with claim 12, wherein the vehicle comprises at one of its rear sides two adjacent tires, wherein the placing the traction aid apparatus on a tire surface comprises placing an elongated main body of the traction aid apparatus over an entire width of a first outer wheel of the adjacent wheels and at least a portion of a width of a second inner wheel of the adjacent wheels.

20. The method in accordance with claim 19, wherein the applying tension causes a second securing member of the traction aid apparatus to move towards a first securing member of the traction aid apparatus, the first securing member applying pressure on a first side wall of the first outer wheel, and the second securing member applying pressure to a second side wall of the first outer wheel, the first side wall of the first outer wheel opposite the second side wall of the first outer wheel.
